(19) United States
(12) Patent Application Publication
(10) Pub. No.: US 2011/0180095 A1
(43) Pub. Date: Jul. 28, 2011

(54) Electric eyelash brush

(76) Inventor: George Chen, Taipei (TW)

(21) Appl. No.: 12/657,576

(22) Filed: Jan. 25, 2010

(51) Int. Cl. A45D 40/26; B43K 29/00

(52) U.S. Cl. 132/218; 401/195

(57) ABSTRACT

An electric eyelash brush has a housing, a motor driving module mounted inside the housing, an eyelash brush connected with the motor driving module and having one end protruding beyond the housing, and a cover detachably combined with the housing to receive one end of the eyelash brush. The motor driving module has a fixing member, a motor mounted inside the housing through the fixing member and a motor control circuit connected with the motor. The motor control circuit is electrically connected with a switch mounted on the housing to control motor to rotate the eyelash brush clockwise and counter-clockwise. The motor control circuit has a timer setting function to stop the motor after exceeding a reasonable operation time so as to secure operational safety. Besides, the eyelash brush can be replaced with eyelash brushes with different forms of eyelash brushes based on users' demand.

### BACKGROUND OF THE INVENTION

1. Field of the Invention

The present invention is related to an electric eyelash brush, and more particularly to an electric eyelash brush rotating clockwise and counter-clockwise, having a timer setting function and automatically stopping when a motor of the electric eyelash brush is operating over a reasonable time.

2. Description of the Related Art

The ancient proverb says “the eyes are the windows to the soul”. To appearance-demanding people, bright and shinning eyes are always the prioritized part to be craved for. Some make-up techniques, such as enhancement of eye-line, eye shadow and eyelash, can satisfy such requirement in some ways. As to eyelash, some people use false eyelash to extend the length of original eyelash, and others apply eyelash brush along with mascara to make original eyelash look longer and more curly. As the degree of curliness is an emphasis when brushing eyelash, users normally hold an eyelash brush in a direction perpendicular to the growing direction of an eyelash to curl the eyelash. Such operation is usually not so convenient due to limited length of eyelash. With reference to FIG. 8, an electric eyelash brush (80) is introduced to tackle such issue. A small motor is mounted inside the electric eyelash brush (80) to rotate a brush (81) mounted in a front end of the electric eyelash brush (80). Users just need to position the brush (81) near an eyelash to conveniently and rapidly curl the eyelash. Conventional electric eyelash brushes tend to start operating after a switch button is pressed once and to shut down after pressing the switch button one more time, so that users don't need to constantly hold the switch button. However, if users neglect to press the switch button one more time after the electric eyelash brushes start operating, the electric eyelash brushes will keep operating until the power is out or the motor is burned out.

Besides, conventional electric eyelash brushes employ permanent fixing means, meaning that the electric eyelash brushes can only operate with one single type of brush and fail to generate different styling effect with different form of brush.

Therefore, conventional eyelash brushes can still be refined.

### SUMMARY OF THE INVENTION

An objective of the present invention is to provide an electric eyelash brush rotating clockwise and counter-clockwise, having a timer setting function and automatically stopping when a motor of the electric eyelash brush is operating over a reasonable time.

To achieve the foregoing objective, the electric eyelash brush has a housing, a motor, a brush module and a cover.

The housing has a switch and at least one battery. The switch is mounted through an outside of the housing. The at least one battery is mounted inside the housing.

The motor driving module is mounted inside the housing and has a fixing member, a motor and a motor control circuit.

The fixing member is mounted inside the housing. The motor is connected to the fixing member and mounted inside the housing. The motor control circuit is electrically connected with the motor, the switch and the at least one battery, controls the motor to switch on and off and to rotate clockwise and counter-clockwise, and has a timer setting function.

The brush module has a sleeve and an eyelash brush. The sleeve has two ends. One of the ends of the sleeve is detachably connected to the housing. The eyelash brush is mounted inside the sleeve and connected with the motor of the motor driving module.

The cover is detachably connected to the other end of the sleeve of the brush module and mounted around the eyelash brush.

After users remove the cover and press the switch, the motor control circuit is activated to drive the motor so as to rotate the eyelash brush clockwise and counter-clockwise. As the motor control circuit has the timer setting function, the motor is stopped to run once the motor operates over a reasonable time, thereby avoiding the battery power to use up or the motor to burn out.

Given a detachable combination of the brush module and the housing, the housing can be combined with brush modules having different forms of eyelash brushes. Different makeup demands of consumers can be met and operational cost can be saved.

### BRIEF DESCRIPTION OF THE DRAWINGS

FIG. 1 is a perspective view of an electric eyelash brush in accordance with the present invention;

FIG. 2 is an exploded perspective view in FIG. 1;

FIG. 3 is another exploded perspective view in FIG. 1;

FIG. 4 is a cross-sectional view in FIG. 1;

FIG. 5 is a partially exploded perspective view in FIG. 1;

FIG. 6 is another partially exploded perspective view in FIG. 1;

FIG. 7 is a circuit diagram of an electric eyelash brush in accordance with the present invention; and

FIG. 8 is a perspective view of a conventional electric eyelash brush.

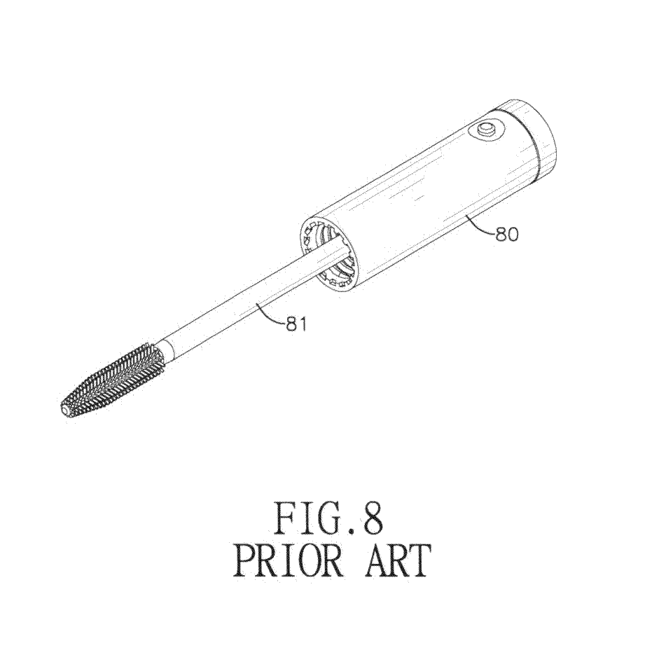

### DETAILED DESCRIPTION OF THE INVENTION

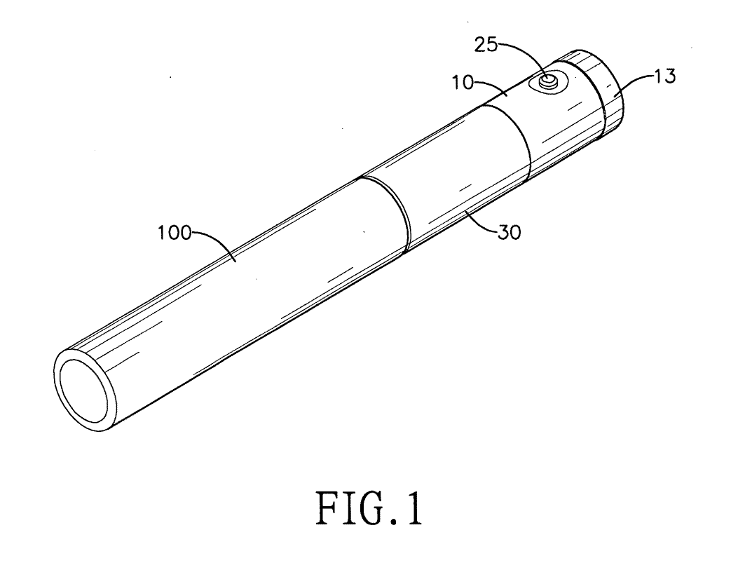

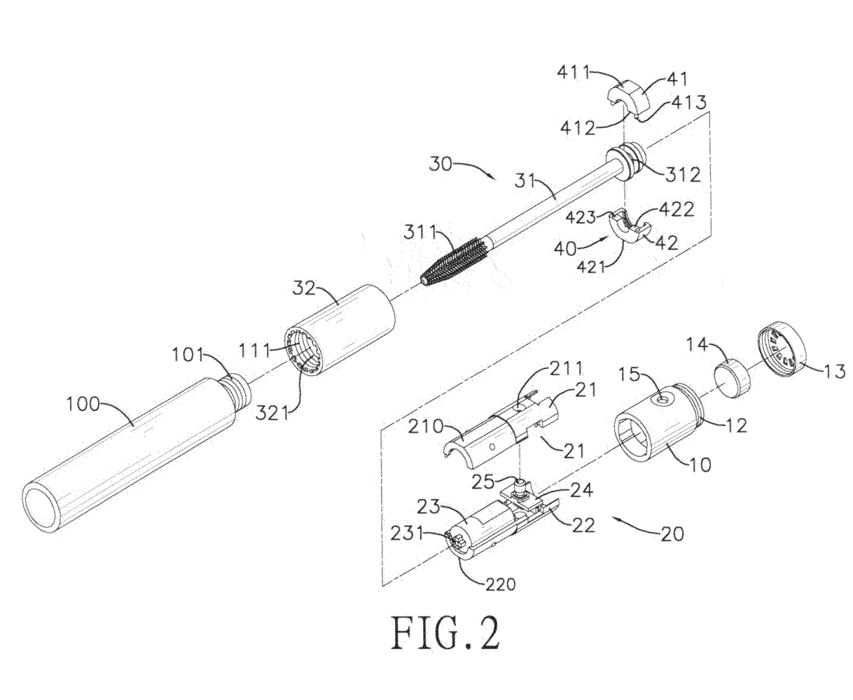

With reference to FIGS. 1 and 2, an electric eyelash brush has a housing (10), a brush module (30), a cover (100) and a motor driving module.

The housing (10) takes a form of a circular tube and has two flat portions (11), a thread (12), a battery cap (13), a battery (14) and a first through hole (15). The two flat portions (11) are oppositely formed on an inner wall of the housing (10). The thread (12) is formed on a periphery at one side of the housing (10) adjacent to the battery cap (13) to screw with the battery cap (13). The battery (14) for supplying an operating power of the electric eyelash brush is received in the housing (10). The first through hole (15) is formed through the housing (10) for mounting a switch.

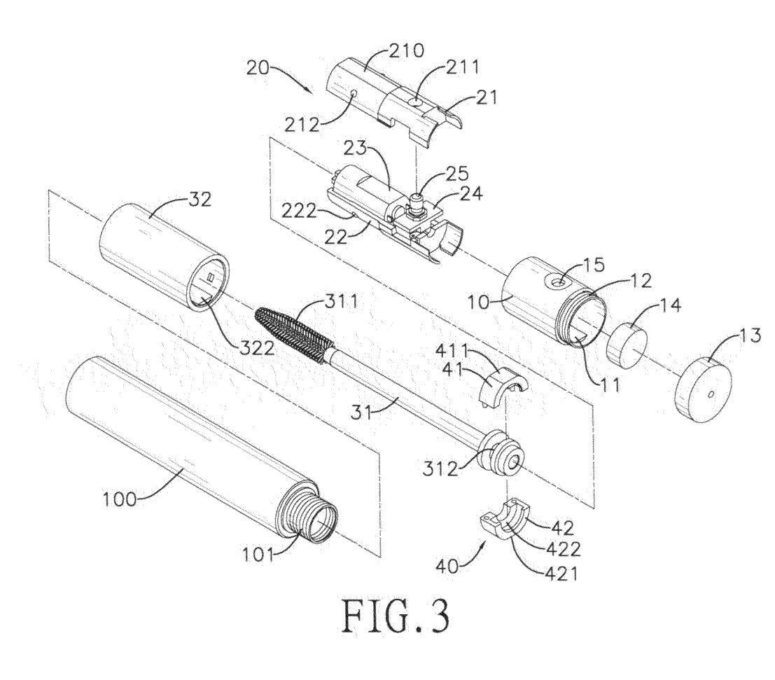

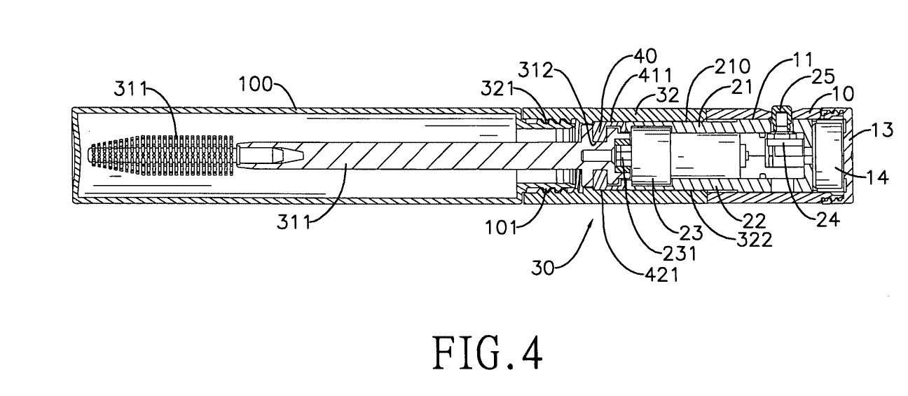

With reference to FIGS. 2 to 4, the motor driving module has a fixing member (20), a motor (23) and a circuit board (24).

The fixing member (20) has an upper fixing element (21) and a lower fixing element (22). Cross sections of the upper fixing element (21) and the lower fixing element (22) are semi-circular. The upper fixing element (21) and the lower fixing element (22) are oppositely mounted together to form a hollow tube having an outer diameter matching an inner diameter of the housing (10). The upper fixing element (21) has a flat surface (210), a second through hole (211) and a bump (212). The lower fixing element (22) has a proximal end, a distal end, a flat surface (220) and a bump (222). The distal end abuts the housing (10). The flat surfaces (210)(220) are respectively and oppositely mounted on the upper fixing element (21) and the lower fixing element (22) to respectively match the flat portions (11) of the housing (10) so that the distal end of the fixing member (20) can be sleeved by the housing (10) firmly. The second through hole (211) is formed through the upper fixing element (21) to align with the first through hole (15) on the housing (10). Moreover, the bumps (212) (222) are respectively formed on peripheries of the proximal end of the fixing member (20) so as to urge against the brush module (20) when the fixing member (20) is sleeved by the brush module (30).

The motor (23) is mounted inside the proximal end of the fixing member (20). A spindle (231) of the motor (23) protrudes beyond the proximal end of the fixing member (20).

The circuit board (24) is mounted on the distal end of the fixing member (20) and has a motor control circuit, a switch (25) and an electrical connection piece (not shown). The switch (25) is mounted through an outside of the housing, and penetrates through and protrudes beyond the second through hole (211) of the upper fixing element (21) and the first through hole (15) of the housing (10) so as to be pressed by users. The circuit board (24) has the electrical connection piece mounted on one end of the circuit board (24) facing the housing (10) to be electrically connected with the battery (14).

The brush module (30) has an eyelash brush (31), a bushing (40) and a sleeve (32). The eyelash brush (31) takes a form of a rod, has a plurality of bristles (311) and an annular groove (312) and is connected with the motor (23). The plurality of bristles (311) are radially formed on a first end of the eyelash brush (31), and an outer diameter of a second end is larger than that of the first end. The annular groove (312) is formed in the second end to facilitate itself be coupled inside the sleeve (32) by the bushing (40).

The bushing (40) has a top bushing (41) and a bottom bushing (42). Cross sections of the top bushing (41) and the bottom bushing (42) are semi-circular. The top bushing (41) and the bottom bushing (42) are oppositely mounted together to form an annular ring. The top bushing (41) has a flat surface (411), a limit protrusion (412) and two pins (413). The bottom bushing (42) has a flat surface (421), a limit protrusion (422) and two pin holes (423). The two flat surfaces (411)(421) are oppositely formed on the top bushing (41) and the bottom bushing (42) respectively. Two semi-circular limit protrusions (412)(422) are respectively formed on and axially protrude from two corresponding ends of the top bushing (41) and the bottom bushing (42). The limit protrusions (412)(422) oppositely insert in the annular groove (312) of the eyelash brush (31). So, the eyelash brush (31) can be prevented from disengaging from the housing while rotating. The two pins (413) are formed on two ends of the limit protrusion (412). The two pin holes (423) are formed on two ends of the limit protrusion (422) to correspond to the two pins (413). Therefore, the top bushing (41) and the bottom bushing (42) can be mutually combined together.

The brush module (30) is located between the housing (10) and the cover (100). The sleeve (32) of the brush module (30) has an inner thread (321) and two flat portions (322). The inner thread (321) is formed on an inner wall of one end of the sleeve (32) abutting the cover (100). The two flat portions (322) are oppositely formed on an inner wall of the sleeve (32) and abut the housing (10) so that the end of the sleeve (32) having the flat portions (322) is non-circular in cross section. Besides matching with the flat surfaces (411)(421) of the top and bottom bushings (41)(42), the flat portions (322) of the sleeve (32) further match with the flat surfaces (210)(220) of the fixing member (20).

The cover (100) is tubular and has a closed end and an open end. The open end has an outer thread (101) formed around the open end to screw with the inner thread (321) of the sleeve (32), thereby facilitating mounting and dismounting the cover (100).

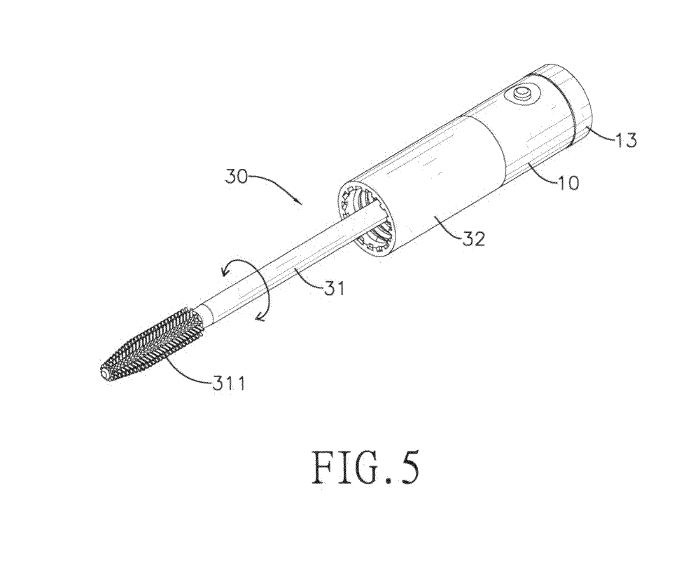

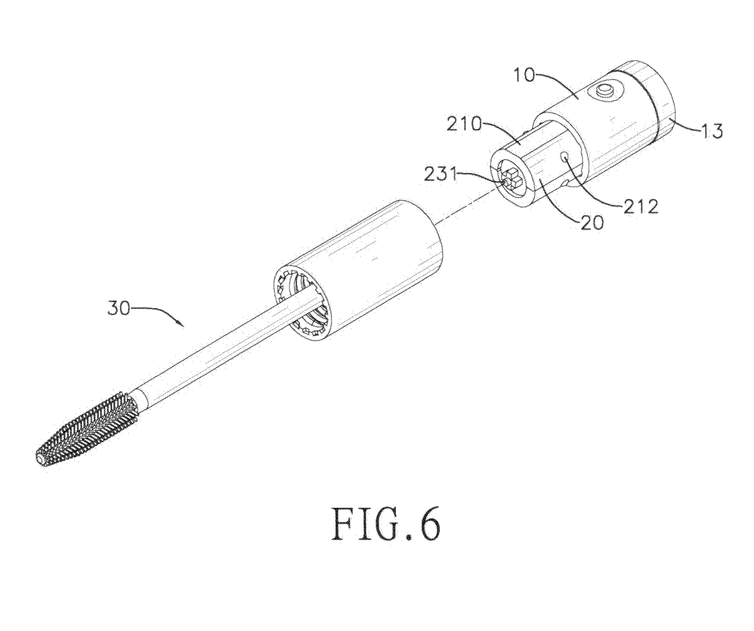

With reference to FIGS. 5 and 6, the brush module (30) can be detachably combined with the fixing member (20). Depending on users' demand, the brush module (30) can be detached from the housing (10) to replace with a brush module (30) having different form of bristles.

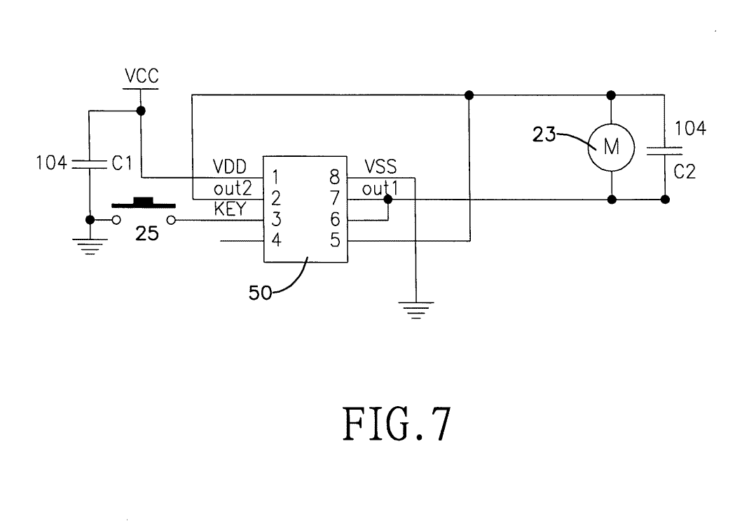

With reference to FIG. 7, the motor control circuit has a driver (50). The driver (50) is built in with a programmable switching control function and a timer setting function. The driver (50) has an input terminal and an output terminal. The input terminal of the driver (50) is electronically connected with the switch (25), and the output terminal is electronically connected with the motor (23). As for the programming switching control function, when the switch (25) is pressed once and released, the motor (23) is driven to rotate clockwise. When the switch (25) is repeatedly pressed twice, the motor (23) stops rotating. When the switch (25) is repeatedly pressed thrice, the motor (23) starts to rotate counter-clockwise. When the switch (25) is repeatedly pressed four times, the motor (23) stops rotating. Regardless of clockwise rotation or counter-clockwise rotation, once a rotation time exceeds a reasonable time to normally operate the electric eyelash brush, for example, after the motor has been rotating clockwise or rotating counter-clockwise for over 3 minutes, the driver (50) stops the motor (23) to rotate. Regularly, the electric eyelash brush is used for less than 3 minutes. If the operation of the electric eyelash brush exceeds 3 minutes, it could be caused very likely by human negligence. In that case, the electric eyelash brush is shut down directly. If the electric eyelash brush is actually operated by users for over 3 minutes, all it needs to do is just to restart the electric eyelash brush, making it a convenient tool to use.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An electric eyelash brush, comprising:
a housing having
a switch mounted through an outside of the housing; and
at least one battery mounted inside the housing;
a motor driving module mounted inside the housing and having
a fixing member mounted inside the housing;
a motor connected to the fixing member and mounted inside the housing; and
a motor control circuit electrically connected with the motor, the switch and the at least one battery, controlling the motor to switch on and off and to rotate clockwise and counter-clockwise, and having a timer setting function;
a brush module having
a sleeve having two ends, one of the ends of the sleeve detachably connected to the housing; and
an eyelash brush mounted inside the sleeve, and connected with the motor of the motor driving module; and
a cover detachably connected to the other end of the sleeve of the brush module and mounted around the eyelash brush.

2. The electric eyelash brush as claimed in claim 1, wherein the fixing member has
a proximal end;
a distal end abutting the housing;
an upper fixing element being semi-circular in cross section, and having a flat surface formed on a periphery of the upper fixing element; and
a lower fixing element being semi-circular in cross section, attached to the upper fixing element to form a hollow tube having an outer diameter matching an inner diameter of the housing, and having
a flat surface formed on a periphery of the lower fixing element and being opposite to the flat surface of the upper fixing element;
the housing has two flat portions formed oppositely on an inner wall at one of two sides of the housing and respectively abutting against the flat surfaces of the upper and lower fixing element; and
the motor is mounted inside the proximal end of the fixing member and has a spindle protruding from the distal end of the fixing member.

3. The electric eyelash brush as claimed in claim 2, wherein
the motor driving module has
a circuit board on which the motor control circuit is formed, and mounted on the distal end of the fixing member; and
an electrical connection piece mounted on one end of the circuit board facing the housing to electrically connect with the at least one battery; and
the housing has
a battery cap;
a thread formed on a periphery of the other side of the housing to screw with the battery cap; and
two through holes respectively formed through the housing and the fixing member and align with each other for the switch mounted on the circuit board to respectively penetrate through and protrude beyond the fixing member and the housing.

4. The electric eyelash brush as claimed in claim 3, wherein multiple bumps are respectively formed on the distal end of the fixing member.

5. The electric eyelash brush as claimed in claim 2, wherein
the brush module has a bushing mounted inside the sleeve;
the eyelash brush has
a first end;
a plurality of bristles radially formed on the first end;
a second end having an outer diameter larger than that of the first end; and
an annular groove formed in the second end to engage with the bushing.

6. The electric eyelash brush as claimed in claim 5, wherein
the bushing has
a top bushing being semi-circular in cross section, and having
a flat surface formed on a periphery of the top bushing; and
a semi-circular limit protrusion formed on and axially protruding from a corresponding side of the top bushing, and inserting in the annular groove of the eyelash brush;
a bottom bushing being semi-circular in cross sections and attached to the top bushing to form an annular ring, and having
a flat surface formed on a periphery of the bottom bushing; and
a semi-circular limit protrusion formed on and axially protruding from a corresponding side of the bottom bushing, and inserting in the annular groove of the eyelash brush; and
the sleeve has two flat portions formed oppositely on an inner wall at one end of the sleeve and respectively abutting against the flat surfaces of the top and bottom bushings.

7. The electric eyelash brush as claimed in claim 6, wherein
the top bushing has two pins respectively formed on two ends of the limit protrusion of the top bushing; and
the bottom bushing has two pin holes respectively formed on two ends of the limit protrusion of the bottom bushing to engage with the two pins, so that the top bushing and the bottom bushing are mutually combined together.

8. The electric eyelash brush as claimed in claim 7, wherein
the sleeve has an inner thread formed on an inner wall of one end of the sleeve; and
the cover is tubular and has
a closed end; and
an open end having an outer thread formed around the open end to screw with the inner thread inside the sleeve.

9. The electric eyelash brush as claimed in claim 1, wherein the motor control circuit has a driver built in with a programmable switching control function, an input terminal electronically connected with the switch and an output terminal electronically connected with the motor, and timer setting function is built in the driver.

10. The electric eyelash brush as claimed in claim 2, wherein the motor control circuit has a driver built in with a programmable switching control function, an input terminal electronically connected with the switch and an output terminal electronically connected with the motor, and timer setting function is built in the driver.

11. The electric eyelash brush as claimed in claim 3, wherein the motor control circuit has a driver built in with a programmable switching control function, an input terminal electronically connected with the switch and an output terminal electronically connected with the motor, and timer setting function is built in the driver.

12. The electric eyelash brush as claimed in claim 4, wherein the motor control circuit has a driver built in with a programmable switching control function, an input terminal electronically connected with the switch and an output terminal electronically connected with the motor, and timer setting function is built in the driver.

13. The electric eyelash brush as claimed in claim 5, wherein the motor control circuit has a driver built in with a programmable switching control function, an input terminal electronically connected with the switch and an output terminal electronically connected with the motor, and timer setting function is built in the driver.

14. The electric eyelash brush as claimed in claim 6, wherein the motor control circuit has a driver built in with a programmable switching control function, an input terminal electronically connected with the switch and an output terminal electronically connected with the motor, and timer setting function is built in the driver.

15. The electric eyelash brush as claimed in claim 7, wherein the motor control circuit has a driver built in with a programmable switching control function, an input terminal electronically connected with the switch and an output terminal electronically connected with the motor, and timer setting function is built in the driver.

16. The electric eyelash brush as claimed in claim 8, wherein the motor control circuit has a driver built in with a programmable switching control function, an input terminal electronically connected with the switch and an output terminal electronically connected with the motor, and timer setting function is built in the driver.
